(19) United States
(12) Patent Application Publication
(10) Pub. No.: US 2025/0158014 A1
(43) Pub. Date: May 15, 2025

(54) ELECTRODE PLATE FOR SECONDARY BATTERY AND MANUFACTURING METHOD THEREFOR

(71) Applicant: Samsung SDI Co., Ltd., Yongin-si (KR)

(72) Inventors: Joong Yong PARK, Yongin-si (KR); Jea Woan LEE, Yongin-si (KR); Hyun Jun CHOI, Yongin-si (KR)

(21) Appl. No.: 18/641,200

(22) Filed: Apr. 19, 2024

(30) Foreign Application Priority Data
Nov. 9, 2023 (KR) 10-2023-0154341

(51) Int. Cl. H01M 4/04; H01M 4/66

(52) U.S. Cl. CPC H01M 4/0435; H01M 4/0404; H01M 4/664

(57) ABSTRACT

An electrode plate for a secondary battery includes: a substrate that is a film-shaped or thin metal foil; an active material layer on at least one side of the substrate; an uncoated portion on one side along the longitudinal direction of the substrate and having no active material layer formed therein; and an auxiliary uncoated portion on the other side along the longitudinal direction of the substrate and having no active material layer formed therein.

### CROSS-REFERENCE TO RELATED APPLICATION

The present application claims priority to and the benefit of Korean Patent Application No. 10-2023-0154341, filed on Nov. 9, 2023, in the Korean Intellectual Property Office, the entire disclosure of which is incorporated herein by reference.

### BACKGROUND

### 1. Field

Aspects of some embodiments of the present disclosure relate to an electrode plate for a secondary battery and a manufacturing method therefor.

### 2. Description of the Related Art

In general, a secondary battery may include an electrode assembly that is laminated or wound with a separator interposed between a positive electrode plate and a negative electrode plate, a case that accommodates the electrode assembly with an electrolyte, and a cap assembly that seals the case.

The positive electrode plate and negative electrode plate, which constitute the electrode assembly, may be formed by applying or coating an active material to one or both sides of a thin or film-shaped metal foil substrate. Each of the positive electrode plate and negative electrode plate may have an uncoated portion on one side to which no active material is applied.

In the manufacturing processes of the positive and negative electrode plates, a rolling process is a process for relatively uniformly applying an active material to a substrate. When the positive electrode plate and the negative electrode plate are rolled, a portion to which the active material may be applied (hereinafter referred to as a mixture part) is stretched longer than the uncoated portion. This is because the elongation of the uncoated portion to which the active material is not applied is different from that of the mixture part. Due to a difference in the elongation, there may be a problem that when cutting an electrode plate, the uncoated portion and the mixture part may become curved rather than being straight. This may make it difficult to achieve accurate punching when cutting electrode plates, and may cause a lot of material to be discarded to secure accurate dimensions.

The above information disclosed in this Background section is only for enhancement of understanding of the background and therefore the information discussed in this Background section does not necessarily constitute prior art.

### SUMMARY

Aspects of some embodiments of the present disclosure relate to an electrode plate for a secondary battery and a manufacturing method therefor, in which curvature of an electrode plate can be prevented reduced during rolling.

Aspects of some embodiments of the present disclosure include an electrode plate for a secondary battery and a manufacturing method therefor, in which curvature of an electrode plate can be prevented or reduced during rolling.

An electrode plate for a secondary battery according to some embodiments of the present disclosure may include: an electrode plate for a secondary battery including: a substrate that is a film-shaped or thin metal foil; an active material layer provided on at least one side of the substrate; an uncoated portion provided on one side along the longitudinal direction of the substrate and having no active material layer formed therein; and an auxiliary uncoated portion provided on the other side along the longitudinal direction of the substrate and having no active material layer formed therein.

According to some embodiments, the auxiliary uncoated portion may have a smaller width than the uncoated portion on the basis of the width direction of the substrate.

According to some embodiments, the electrode plate may further comprise a ceramic coating layer coated along the longitudinal direction of the auxiliary uncoated portion.

According to some embodiments, the ceramic coating layer may cover the auxiliary uncoated portion, a boundary area between the auxiliary uncoated portion and the active material layer, and a portion of the active material layer.

According to some embodiments, the ceramic coating layer may be a single ceramic material or a ceramic mixed material.

According to some embodiments, when the ceramic coating layer is made of a ceramic mixed material, the mixing ratio of ceramic and a binder is 85:15.

According to some embodiments, the ceramic coating layer may have a single-layer structure.

According to some embodiments, the ceramic coating layer may have a thickness of 10-30 μm.

Aspects of some embodiments of the present disclosure include a method for manufacturing an electrode plate for a secondary battery, the method including: applying an active material to at least one surface of a substrate, excluding areas of an uncoated portion and an auxiliary uncoated portion, to one side and the other side of the substrate in the longitudinal direction; forming a ceramic coating layer along the longitudinal direction of the auxiliary uncoated portion; and rolling the substrate and the active material along the longitudinal direction of the substrate to mix the active material with the substrate.

According to some embodiments, the auxiliary uncoated portion may have a smaller width than the uncoated portion on the basis of the width direction of the substrate.

According to some embodiments, the ceramic coating layer may cover the auxiliary uncoated portion, a boundary area between the auxiliary uncoated portion and the active material layer, and a portion of the active material layer.

According to some embodiments, the ceramic coating layer may be a single ceramic material or a ceramic mixed material.

According to some embodiments, when the ceramic coating layer is made of a ceramic mixed material, the mixing ratio of ceramic and a binder may be 85:15.

According to some embodiments, the ceramic coating layer may be a single-layer structure.

According to some embodiments, the ceramic coating layer may have a thickness of 10-30 μm.

### BRIEF DESCRIPTION OF DRAWINGS

FIG. 1 is a plan view briefly showing an electrode plate according to some embodiments of the present disclosure.

FIG. 2 is a plan view briefly showing a state in which a ceramic coating layer is formed on the electrode plate of FIG. 1 according to some embodiments of the present disclosure.

FIG. 3 is a plan view briefly showing the states of an electrode plate according to some embodiments of the present disclosure and an electrode plate according to comparative example, in a rolling process.

### DETAILED DESCRIPTION

Embodiments of the present disclosure are provided to more fully describe aspects of some embodiments of the present disclosure to those skilled in the art, and the following embodiments may be embodied in many different forms and should not be construed as being limited to the example embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components are exaggerated for brevity and clarity. Like numbers refer to like elements throughout. In addition, it will be understood that when an element A is referred to as being “connected to” an element B, the element A can be directly connected to the element B or an intervening element C may be present therebetween such that the element A and the element B are indirectly connected to each other. As used herein, the term “and/or” includes any and all combinations of one or more of the associated listed items.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the term “below” can encompass both an orientation of above and below.

Hereinafter, an electrode plate for a secondary battery and a manufacturing method therefor, according to some embodiments of the present disclosure, will be described in more detail with reference to the attached drawings.

First, aspects of an electrode plate for a secondary battery will be described in more detail.

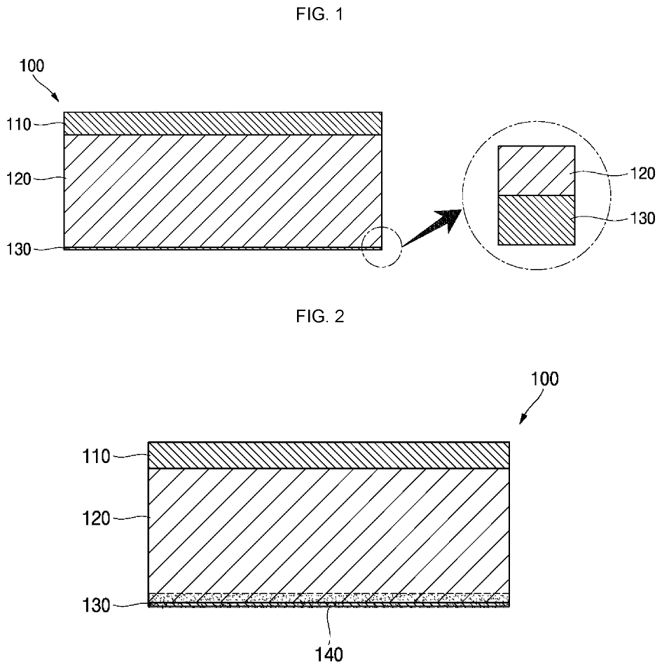

FIG. 1 is a plan view briefly showing an electrode plate according to some embodiments of the present disclosure. FIG. 2 is a plan view briefly showing a state in which a ceramic coating layer is formed on the electrode plate of FIG. 1.

Referring to FIGS. 1 and 2, an electrode plate 100 for a secondary battery according to some embodiments of the present disclosure may include a substrate and an active material layer 120 provided on the substrate. An uncoated portion 110 without an active material layer may be provided in some areas of the substrate. In addition, the electrode plate 100 may further include an auxiliary uncoated portion 130 and a ceramic coating layer 140. Here, the electrode plate 100 may be a positive electrode plate or a negative electrode plate.

When the electrode plate 100 is a positive electrode plate, the substrate may be a metal foil such as aluminum or an aluminum alloy. The active material layer is provided on one or both sides of the substrate, and the active material layer may be made of a positive electrode active material such as a transition metal oxide. In more detail, a compound capable of reversible intercalation and deintercalation of lithium (lithiated intercalation compound) may be used as the positive electrode active material. For example, one or more types of complex oxides of lithium and a metal selected from cobalt, manganese, nickel, and combinations thereof may be used as the positive electrode active material. The complex oxide may be a lithium transition metal complex oxide, and specific examples thereof may include lithium nickel-based oxide, lithium cobalt-based oxide, lithium manganese-based oxide, lithium iron phosphate-based compound, cobalt-free nickel-manganese-based oxide, or a combination thereof.

When the electrode plate 100 is a negative electrode plate, the substrate may be a metal foil such as copper, a copper alloy, nickel, or a nickel alloy. The active material layer is provided on one or both sides of the substrate, and the active material layer may be made of a negative electrode active material such as graphite or carbon. In more detail, the negative electrode active material includes a material capable of reversibly intercalating/deintercalating lithium ions, lithium metal, an alloy of lithium metal, a material capable of doping and dedoping lithium, or a transition metal oxide. The material capable of reversibly intercalating/deintercalating lithium ions is a carbon-based negative electrode active material, and may include, for example, crystalline carbon, amorphous carbon, or a combination thereof. Examples of the crystalline carbon may include graphite such as natural graphite or artificial graphite, and examples of the amorphous carbon may include soft carbon or hard carbon, mesophase pitch carbide, calcined coke, etc. As the material capable of doping and dedoping lithium, a Si-based negative electrode active material or a Sn-based negative electrode active material may be used. The Si-based negative electrode active material may be silicon, silicon-carbon composite, SiOx (0<x<2), Si-based alloy, or a combination thereof. The silicon-carbon composite may be a composite of silicon and amorphous carbon. According to some embodiments, the silicon-carbon composite may be in the form of silicon particles and amorphous carbon coated on the surface of the silicon particles. The silicon-carbon composite may further include crystalline carbon. For example, the silicon-carbon composite may include a core containing crystalline carbon and silicon particles and an amorphous carbon coating layer located on the surface of the core.

The metal foil before the active material layer 120 is provided is generally referred to as a substrate. Because the active material layer 120 is rolled on the substrate and integrally formed, the active material layer 120 is also referred to as a mixture part. Generally, after the active material layer 120 is mixed into the substrate, the remaining portion of the substrate without the active material layer 120 is referred to as the uncoated portion 110. According to some embodiments, the uncoated portion 110 may be provided on one side of the electrode plate 100 along the longitudinal direction. In addition, according to some embodiments, the auxiliary uncoated portion 130 may be provided on the opposite side of the uncoated portion 110.

The auxiliary uncoated portion 130 may be provided on the other side of the electrode plate 100 along the longitudinal direction. When the active material layer 120 is formed to provide the auxiliary uncoated portion 130, the active material is not coated on a certain area opposite the uncoated portion 110. Accordingly, the uncoated portion 110 and the auxiliary uncoated portion 130 may be provided to face each other along the longitudinal direction of the electrode plate 100. If the active material layer 120 is provided on both sides of the substrate, the auxiliary uncoated portion 130 may also be formed on both sides of the substrate. In addition, the auxiliary uncoated portion 130 may be provided to have a smaller width than the uncoated portion 110. Here, the term “width” refers to the width direction length of the electrode plate 100. Because the auxiliary uncoated portion 130 is a portion of the substrate, the auxiliary uncoated portion 130 and the substrate have the same elongation. The ceramic coating layer 140 is provided on the auxiliary uncoated portion 130.

Referring to FIG. 2, the ceramic coating layer 140 is provided at the boundary area between the auxiliary uncoated portion 130 and the active material layer 120, and in a partial area of the active material layer 120. The ceramic coating layer 140 may cover the entire auxiliary uncoated portion 130. In addition, the ceramic coating layer 140 may cover the boundary between the auxiliary uncoated portion 130 and the active material layer 120 and the partial area of the active material layer 120. That is, the ceramic coating layer 140 may be provided to be larger than the auxiliary uncoated portion 130. As an example, the ceramic coating layer 140 may be provided to be smaller than the width of the uncoated portion 110 (the length in the width direction of an electrode plate). However, if the size of the active material layer 120 required is sufficient, the ceramic coating layer 140 may be provided to have the same size as the uncoated portion 110. In some embodiments, the ceramic coating layer 140 may be provided on one side of the substrate. Alternatively, in some embodiments, the ceramic coating layer 140 may be provided on both sides of the substrate. The ceramic coating layer 140 is for preventing or reducing instances of the electrode plate 100 being curved because the elongation rate of the active material layer 120 is higher than that of the substrate. Although the auxiliary uncoated portion 130 has the same elongation as the substrate, the area size is smaller than that of the uncoated portion. Therefore, in order to prevent or reduce stretching of the active material layer 120, the elongation of the ceramic coating layer 140 may be similar to or the same as the elongation of the substrate. To this end, the ceramic coating layer 140 may be provided as a single ceramic material or a mixed ceramic material in which several auxiliary components are mixed.

As an example, the mixed ceramic material may be a material having ceramic and a binder mixed therein. The ceramic may include alumina, Boehmite, etc., and the binder may include polyvinylidene fluoride (PVdF). The ceramic and the binder may be mixed in a ratio of 85:15.

The ceramic coating layer 140 may be provided in a single layer structure regardless of whether it is a single ceramic or a mixed ceramic material. As an example, the ceramic coating layer 140 may be provided to have a thickness of 20 μm (10-30 μm as needed). In addition, as an example, the ceramic coating layer 140 may be provided simultaneously with the process of mixing and coating a positive electrode mixture part. When mixing the positive electrode active material, the coating material may also be mixed separately to form a positive electrode coating layer, and at the same time, the ceramic coating layer 140 may be formed only in desired or necessary areas. That is, while the positive electrode active material is coated by a positive electrode coating device, a separate coating device may form the ceramic coating layer 140 by using a coating shim (a type of discharge head capable of determining the coating width when discharging an active material slurry).

Hereinafter, some processes in the manufacturing processes of the electrode plate having the above-described structure will be described in more detail.

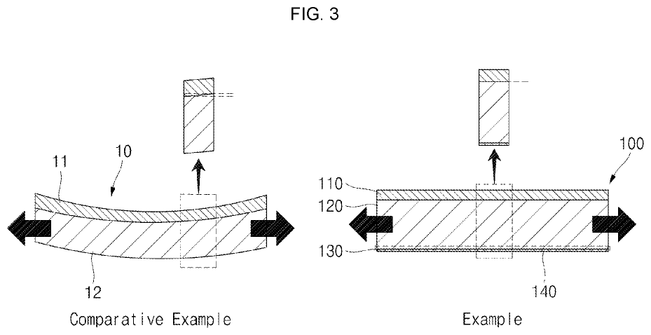

FIG. 3 is a plan view briefly showing the states of an electrode plate according to an example of the present disclosure and an electrode plate according to Comparative Example, in the rolling process.

FIG. 3 shows the states of a general electrode plate (comparative example, 10) without an auxiliary uncoated portion and a ceramic coating layer in a rolling process and the electrode plate 100 according to some embodiments of the present disclosure. The rolling process is a process of pressing the electrode plates 10 and 100 along the longitudinal direction. In this process, both the uncoated portion 11 and the active material layer 12 of the electrode plate 10 of Comparative Example are stretched in the longitudinal direction of the electrode plate 10. Here, because the elongation of the active material layer 12 is greater than that of the uncoated portion 11, the mixture part is stretched more than the uncoated portion 11. Accordingly, a curve occurs in which both ends of the electrode plate 10 in the longitudinal direction are curved toward the uncoated portion 11.

However, according to some embodiments of the present disclosure, the auxiliary uncoated portion 130 having the same elongation as the substrate is provided on the opposite side of the substrate, and the ceramic coating layer 140 is provided thereon. Accordingly, the auxiliary uncoated portion 130 and the ceramic coating layer 140 can block the stretching of the active material layer 120 in a dual manner. Accordingly, even if being stretched along the longitudinal direction, the electrode plate 100 can be rolled straight without being curved in one direction. Therefore, when punching the electrode plate 100, a straight section of the active material layer 120 can be secured and accurate alignment can be achieved. In addition, by achieving accurate punching, discarded materials can be reduced and manufacturing costs can also be reduced.

As described above, according to some embodiments of the present disclosure, by forming the auxiliary uncoated portion on the opposite side of the uncoated portion of the electrode plate, an area where ceramic coating can be applied may be produced. By applying a ceramic coating to the auxiliary uncoated portion, curvature of the electrode plate due to a difference in the elongation between the base material and the mixture part can be prevented or reduced.

While the foregoing embodiments has been described to practice the present disclosure, it should be understood that the embodiments described herein should be considered in a descriptive sense only and not for purposes of limitation, and various changes in form and details may be made therein without departing from the spirit and scope of the disclosure as defined by the following claims, and their equivalents.

What is claimed is:

1. An electrode plate for a secondary battery, comprising:
a substrate that is a film-shaped or thin metal foil;
an active material layer on at least one side of the substrate;
an uncoated portion on a first side along a longitudinal direction of the substrate and having no active material layer formed therein; and
an auxiliary uncoated portion on a second side along the longitudinal direction of the substrate and having no active material layer formed therein.

2. The electrode plate as claimed in claim 1, wherein the auxiliary uncoated portion has a smaller width than the uncoated portion in a width direction of the substrate.

3. The electrode plate as claimed in claim 2, further comprising a ceramic coating layer coated along the longitudinal direction of the auxiliary uncoated portion.

4. The electrode plate as claimed in claim 3, wherein the ceramic coating layer covers the auxiliary uncoated portion, a boundary area between the auxiliary uncoated portion and the active material layer, and a portion of the active material layer.

5. The electrode plate as claimed in claim 4, wherein the ceramic coating layer is a single ceramic material or a ceramic mixed material.

6. The electrode plate as claimed in claim 5, wherein the ceramic coating layer is made of a ceramic mixed material, and a mixing ratio of ceramic and a binder is 85:15.

7. The electrode plate as claimed in claim 3, wherein the ceramic coating layer has a single-layer structure.

8. The electrode plate as claimed in claim 7, wherein the ceramic coating layer has a thickness in a range of 10-30 μm.

9. A method for manufacturing an electrode plate for a secondary battery, the method comprising:
applying an active material to at least one surface of a substrate, excluding areas of an uncoated portion and an auxiliary uncoated portion, to a first side and a second side of the substrate in a longitudinal direction to form an active material layer;
forming a ceramic coating layer along the longitudinal direction of the auxiliary uncoated portion; and
rolling the substrate and the active material along the longitudinal direction of the substrate to mix the active material with the substrate.

10. The method as claimed in claim 9, wherein the auxiliary uncoated portion has a smaller width than the uncoated portion in a width direction of the substrate.

11. The method as claimed in claim 10, wherein the ceramic coating layer covers the auxiliary uncoated portion, a boundary area between the auxiliary uncoated portion and the active material layer, and a portion of the active material layer.

12. The method as claimed in claim 11, wherein the ceramic coating layer covers the auxiliary uncoated portion, a boundary area between the auxiliary uncoated portion and the active material layer, and a portion of the active material layer.

13. The method as claimed in claim 12, wherein the ceramic coating layer is made of a ceramic mixed material, and a mixing ratio of ceramic and a binder is 85:15.

14. The method as claimed in claim 12, wherein the ceramic coating layer has a single-layer structure.

15. The method as claimed in claim 14, wherein the ceramic coating layer has a thickness in a range of 10-30 μm.
